(19) United States
(12) Patent Application Publication
(10) Pub. No.: US 2022/0196429 A1
(43) Pub. Date: Jun. 23, 2022

(54) NAVIGATION BASED ON A USER'S PERCEPTION

(71) Applicant: HERE Global B.V., Eindhoven (NL)

(72) Inventor: Priyank SAMEER, Mumbai (IN)

(21) Appl. No.: 17/125,594

(22) Filed: Dec. 17, 2020

(51) Int. Cl. G01C 21/36; G01C 21/34

(52) U.S. Cl. CPC G01C 21/3632; G01C 21/3484; G01C 21/3602; G01C 21/3682

(57) ABSTRACT

A method, apparatus and computer program product are provided. The method comprises:
receiving a request for a route for a user between an origin and a destination;
identifying a route for the user between the origin and the destination using a user-subjective-navigational-marker-perception profile for the user and according to a predetermined suitability criterion, wherein the user-subjective-navigational-marker-perception profile comprises data about the user's subjective perception of navigational markers, and wherein the identified route includes navigational markers along the route which are flagged based on the user-subjective-navigational-marker-perception profile; and
providing the identified route for user navigation.

### TECHNICAL FIELD

The present application relates to methods, apparatus and computer program products for providing a route for a user. In particular, the present application relates to using a user-subjective-navigational-marker-perception profile for a user to provide a suitable route for the user.

### BACKGROUND

Conventionally in the field of navigation, a user can request a route between an origin and destination and be provided with a suitable route. Route guidance (e.g. turn-by-turn instructions for the route) can also be provided to the user. However, there is room for improvement in both the routes and the associated route guidance that is provided to users.

The listing or discussion of a prior-published document or any background in this specification should not necessarily be taken as an acknowledgement that the document or background is part of the state of the art or is common general knowledge.

### SUMMARY

According to a first aspect, there is provided a computer-implemented method comprising:
receiving a request for a route for a user between an origin and a destination;
identifying a route for the user between the origin and the destination using a user-subjective-navigational-marker-perception profile for the user and according to a predetermined suitability criterion, wherein the user-subjective-navigational-marker-perception profile comprises data about the user's subjective perception of navigational markers, and wherein the identified route includes navigational markers along the route which are flagged based on the user-subjective-navigational-marker-perception profile; and
providing the identified route for user navigation.

Navigational markers may include one or more of a building, a religious building, a retail building, a gas station, a bus stop, a tram stop, a traffic light, a road sign, a bollard, a bridge, an overpass, a parked vehicle, a non-parked vehicle, a tree, a mailbox, a telephone box, a street lamp, a monument, a bench, a fountain, another item of street furniture, and a pedestrian.

The data about the user's subjective perception of navigational markers may comprise one or more perceivable navigational marker attributes, wherein a navigational marker having one of these attributes is considered to be perceivable by the user.

The one or more perceivable navigational marker attributes may comprise one or more of:
a colour of navigational marker that the user perceives before other colours of navigational markers;
a type of navigational marker that the user perceives before other types of navigational markers;
a size of navigational marker that the user perceives before other sizes of navigational marker;
a direction relative to a direction of travel along a road segment in which the user perceives navigational markers before other directions relative to a direction of travel;
a distance from the user at which the user perceives navigational markers before other distances from the user;
whether the user perceives permanent or temporary navigational markers first; and
whether the user perceives static or dynamic navigational markers first.

The data about the user's subjective perception of navigational markers may further comprise a perceptibility ranking of perceivable navigational marker attributes, wherein a navigational marker having a higher-ranked attribute is considered to be more perceivable by the user than a navigational marker having a lower-ranked attribute.

The data about the user's subjective perception of navigational markers may comprise one or more unperceivable navigational marker attributes, wherein a navigational marker having one of these attributes is considered to be not perceivable by the user.

The data about the user's subjective perception of navigational markers may further comprise a perceptibility ranking of unperceivable navigational marker attributes, wherein a navigational marker having a higher-ranked attribute is considered to be more perceivable (less unperceivable) by the user than a navigational marker having a lower-ranked attribute.

Similarly to the examples of perceivable navigational marker attributes listed above, the one or more unperceivable navigational marker attributes may comprise one or more of:
a colour of navigational marker that the user perceives after other colours of navigational markers;
a type of navigational marker that the user perceives after other types of navigational markers;
a size of navigational marker that the user perceives after other sizes of navigational marker;
a direction relative to a direction of travel along a road segment in which the user perceives navigational markers after other directions relative to a direction of travel;
a distance from the user at which the user perceives navigational markers after other distances from the user;
whether the user perceives permanent or temporary navigational markers last; and
whether the user perceives static or dynamic navigational markers last.

Identifying a route for the user between the origin and the destination route for the user between the origin and the destination may comprise selecting one of a plurality of pre-calculated routes from the origin to the destination route for the user between the origin and the destination.

One or more of the plurality of pre-calculated routes may have an associated attribute describing a category of navigational markers located along the route. Selecting one of the plurality of pre-calculated routes from the origin to the destination may comprise:
comparing the one or more attributes associated with the one or more pre-calculated routes to the user-subjective-navigational-marker-perception profile; and
selecting one of the plurality of pre-calculated routes based, at least in part, on the comparison.

The method may further comprise accessing road network data for a geographic area including the origin and destination. The road network data may include road segment data, node data, a plurality of navigational markers located along the road network, and an association between each navigational marker and one or more road segments or nodes that the respective navigational marker is located on or near.

Selecting one of the plurality of pre-calculated routes from the origin to the destination may comprise:
calculating a user perception rating for each of the plurality of pre-calculated routes using accessed road network data and the user-subjective-navigational-marker-perception profile, wherein the user perception rating represents a perceptibility to the user of the navigational markers along the road segments of the respective route; and
selecting one of the plurality of pre-calculated routes based, at least in part, on the user perception ratings.

Identifying a route for the user between the origin and the destination may comprise calculating a route from the origin to the destination using the road network data and the user-subjective-navigational-marker-perception profile by maximising a user perception rating for the route, wherein a user perception rating for a route represents a perceptibility to the user of the navigational markers along the road segments of the route.

The accessed road network data may further comprise a user perception rating for each of a plurality of road segments and/or nodes, wherein each user perception rating represents a perceptibility to the user of the navigational markers along the respective road segment and/or around the respective node as calculated using the user-subjective-navigational-marker-perception profile for the user. The user perception rating for a route may be calculated using the user perception ratings for the road segments and/or nodes forming the route.

The user perception rating for a route may be calculated based on at least one of:
the number of road segments of the route that are associated with more than a threshold number of navigational markers that are perceivable by the user;
the number of road segments of the route that are associated with fewer than a threshold number of navigation markers that are perceivable by the user;
the number of nodes of the route that are associated with more than a threshold number of navigational markers that are perceivable by the user;
the number of nodes of the route that are associated with fewer than a threshold number of navigational markers that are perceivable by the user;
the number of maneuvers in the route that are associated with more than a threshold number of navigational markers that are perceivable by the user;
the number of maneuvers of the route that are associated with fewer than a threshold;
the proportion of the route that is associated with more than a threshold number of navigational markers that are perceivable by the user;
the proportion of the route that is associated with fewer than a threshold number of navigational markers that are perceivable by the user;
a total distance along the route that is associated with more than a threshold number of navigational markers that are perceivable by the user;
a total distance along the route that associated with fewer than a threshold number of navigational markers that are perceivable by the user; or
a maximum single distance along the route that is associated with fewer than a threshold number of navigational markers.

The user-subjective-navigational-marker-perception profile may have been generated based on received input from a user for each of a plurality of road scene images, each road scene image including two or more navigational markers, each navigational marker having one or more associated attributes, wherein the received user input indicates one or more navigational markers that the user perceives before other navigational markers in the respective road scene image.

The method may further comprise generating the user-subjective-navigational-marker-perception profile by:
providing the user with a plurality of road scene images, each road scene image including two or more navigational markers, each navigational marker having one or more associated attributes;
for each of the plurality of road scene images, receiving input from the user indicating one or more navigational markers that the user perceives before other navigational markers; and
storing data about the user's subjective perception of navigational markers based on the received input.

The method may further comprise:
identifying a road segment, node or maneuver of the identified route which is associated with fewer than a threshold number of navigational markers that are, according to the user-subjective-navigational-marker-perception profile, perceivable by the user;
providing the user with a road scene image for the identified road segment, node or maneuver, the road scene image including two or more navigational markers;
receiving input from the user indicating one or more navigational markers that the user perceives before other navigational markers in the road scene image;
modifying the identified route so that the modified route positively flags the one or more navigational markers indicated by the user.

The input from the user may be received via one or more of: a gaze-tracking device, a microphone, a touchscreen, a touchpad, a keyboard and a mouse.

The method may further comprise:
receiving sensor data from one or more sensors located along road segments of the road network, wherein the sensor data includes the locations of one or more detected navigational markers along one or more road segments of the road network,
wherein identifying the route for the user between the origin and the destination uses the locations of the one or more detected navigational markers.

The sensors may include one or more of: a camera located on a probe vehicle, and a CCTV camera.

The user-subjective-navigational-marker-perception profile may comprise data about the user's subjective perception of navigational markers in one or more particular weather conditions, in one or more particular types of geographic area, at one or more particular times of day, in one or more particular months of the year, and/or in one or more particular seasons of the year.

The steps of any method disclosed herein do not have to be performed in the exact order disclosed, unless explicitly stated or understood by the skilled person.

According to a second aspect, there is provided an apparatus comprising:
at least one processor; and
at least one memory including computer program code;
the at least one memory and the computer program code configured to, with the at least one processor, cause the apparatus to:
receive a request for a route for a user between an origin and a destination;
identify a route for the user between the origin and the destination using a user-subjective-navigational-marker-perception profile for the user and according to a predetermined suitability criterion, wherein the user-subjective-navigational-marker-perception profile comprises data about the user's subjective perception of navigational markers, and wherein the identified route includes navigational markers along the route which are flagged based on the user-subjective-navigational-marker-perception profile; and
provide the identified route for user navigation.

The apparatus may be further caused to perform each of the method steps discussed above in relation to the first aspect.

Corresponding computer programs for implementing one or more steps of the methods disclosed herein are also within the present disclosure and are encompassed by one or more of the described examples.

For example, in a third aspect there is provided a computer program comprising instructions which, when the program is executed by a computer, cause the computer to:
receive a request for a route for a user between an origin and a destination;
identify a route for the user between the origin and the destination using a user-subjective-navigational-marker-perception profile for the user and according to a predetermined suitability criterion, wherein the user-subjective-navigational-marker-perception profile comprises data about the user's subjective perception of navigational markers, and wherein the identified route includes navigational markers along the route which are flagged based on the user-subjective-navigational-marker-perception profile; and
provide the identified route for user navigation.

One or more of the computer programs may, when run on a computer, cause the computer to configure any apparatus, including a battery, circuit, controller, or device disclosed herein or perform any method disclosed herein. One or more of the computer programs may be software implementations, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

One or more of the computer programs may be provided on a computer readable storage medium, which may be a physical computer readable storage medium such as a disc or a memory device, may be a non-transitory storage medium, or may be embodied as a transient signal. Such a transient signal may be a network download, including an internet download.

For example, in a fourth aspect, there is provided a computer-readable storage medium comprising instructions which, when executed by a computer, cause the computer to:
receive a request for a route for a user between an origin and a destination;
identify a route for the user between the origin and the destination using a user-subjective-navigational-marker-perception profile for the user and according to a predetermined suitability criterion, wherein the user-subjective-navigational-marker-perception profile comprises data about the user's subjective perception of navigational markers, and wherein the identified route includes navigational markers along the route which are flagged based on the user-subjective-navigational-marker-perception profile; and
provide the identified route for user navigation.

The present disclosure includes one or more corresponding aspects, examples or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

Some example embodiments will now be described with reference to the accompanying drawings, in which:

FIG. 1 shows a system according to one embodiment of the present disclosure;

FIG. 2 shows an apparatus according to one embodiment of the present disclosure;

FIG. 3 shows a schematic road scene image according to one embodiment of the present disclosure;

FIG. 4 shows a schematic road scene image according to another embodiment of the present disclosure;

FIG. 5 shows schematically the main steps of a method described herein;

FIG. 6 shows a portion of a road network and a plurality of navigational markers according to one embodiment of the present disclosure;

FIG. 7 shows a portion of a road network according to one embodiment of the present disclosure;

FIG. 8 shows the portion of the road network in FIG. 7 and a plurality of navigational markers;

FIG. 9a shows a table relating to the road segments in the portion of the road network in FIG. 7;

FIG. 9b shows a table relating to the nodes in the portion of the road network in FIG. 7;

FIG. 10a shows a table relating to the road segments along a first route along the portion of the road network in FIG. 7;

FIG. 10b shows a table relating to the nodes along a first route along the portion of the road network in FIG. 7;

FIG. 11a shows a table relating to the road segments along a second route along the portion of the road network in FIG. 7;

FIG. 11b shows a table relating to the nodes along a second route along the portion of the road network in FIG. 7; and

FIG. 12 shows schematically an example computer-readable medium comprising a computer program configured to perform, control or enable the method of FIG. 5.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Where applicable, like reference numerals refer to like elements. As used herein, the terms “data,” “content,” “information,” and similar terms may be used interchangeably to refer to data capable of being transmitted, received and/or stored in accordance with embodiments of the present invention. Thus, use of any such terms should not be taken to limit the scope of embodiments of the present invention.

The present disclosure relates to methods, apparatus, and computer program products for identifying a route for a user and providing the route for user navigation.

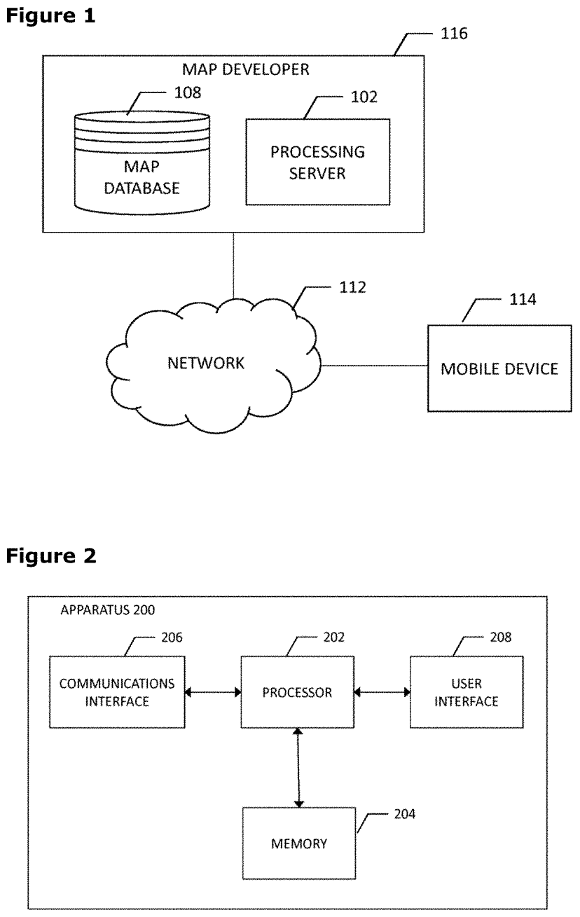

FIGS. 1 and 2 show a system and apparatus respectively which may, in some embodiments, perform methods described herein. FIG. 1 shows a system including a map developer system 116, comprising a map database 108 and a processing server 102, in communication with one or more mobile devices 114 via a network 112. The network may be wired, wireless, or any combination of wired and wireless communication networks, such as cellular, Wi-Fi, internet, local area networks, or the like. Additional, different, or fewer components may be provided. For example, the map developer system 116 may communication with many mobile devices 114 via the network 112.

The mobile device 114 may include a portable computing device such as a laptop computer, tablet computer, mobile phone, smart phone, portable navigation device, personal data assistant (PDA), wearable electronic device, camera, or the like. Additionally or alternatively, the user equipment 104 may be a fixed computing device, such as a personal computer, computer workstation, kiosk, office terminal computer or system, or the like.

In some embodiments, the mobile device 114 may be carried by/within a vehicle. In some embodiments, the mobile device 114 may be an in-vehicle navigation system (associated with, coupled with, otherwise integrated with a vehicle), such as an advanced driver assistance system (ADAS), a personal navigation device (PND), a portable navigation device, a mobile telephone, a smart phone, a personal digital assistant (PDA), a wearable electronic device, a camera, a computer and/or any other device that can perform navigation-related functions, such as route calculation, route guidance or map display. Regardless of whether the mobile device 114 is located in or on a vehicle, is an in-vehicle navigation system or is independent of a vehicle, in some embodiments an end user can use the mobile device 114 for navigation-related functions such as route calculation, route guidance or map display.

Embodiments described herein may be implemented in autonomous, semi-autonomous, or non-autonomous vehicles. Autonomous vehicles may include vehicles that can be driven entirely by software and hardware components, without requiring human interaction. Non-autonomous vehicles are vehicles that have no autonomy and require a human driver to perform all driving activities. Semi-autonomous vehicles are vehicles that fall anywhere between autonomous and non-autonomous vehicles, where there is some degree of autonomy, which may include any form of driver aid such as steering assistance, acceleration/deceleration assistance, adaptive cruise control, etc.

The processing server 102 may be one or more fixed or mobile computing devices. The mobile device 114 may be configured to access the map database 108 via network 112 and via the processing server 102 through, for example, a mapping application, such that the mobile device 114 may provide navigational assistance to a user through access to the map developer system 116.

The map database 108 may include road segment data records (or equivalently ‘link data’), node data records, and/or point of interest (POI) data records. The map database 108 may also include cartographic data, routing data, maneuvering data and/or other types of data.

The road segment data records may be segments or links representing roads, streets, or paths, as may be used in calculating a route. In some embodiments, the links or roadways may be represented by polylines, where each polyline comprises a plurality of vertices establishing the path of the roadway geometry. The node data may be end points corresponding to respective links or segments of road segment data. The road segments and/or nodes can be associated with attributes, such as geographic coordinates, street names, address ranges, speed limits, turn restrictions at intersections, and other navigation related attributes. In some embodiments, the road link data and the node data may represent a road network, such as used by vehicles, cars, trucks, buses, motorcycles, bicycles and/or other entities. Optionally, the map database 108 may contain path segment data records and/or node data records, or other data, that may represent pedestrian paths or areas, in addition to or instead of the vehicular road network data.

The point of interest data records represent points of interest in the geographic area represented by the map database 108, such as gas stations, hotels, restaurants, museums, stadiums, offices, auto repair shops, buildings, stores, parks, etc. The POI data records can include data about the POIs and their respective locations, for example opening hours, accessibility information, facilities, reviews and photos. In some embodiments, the road segment data records and/or node data records can be associated with (e.g. include identifiers of or links to) points of interest (POIs). The map database 108 may include data about places, such as cities, towns or other communities, and other geographic features such as bodies of water or mountain ranges. Such place or feature data (such as a data point used for displaying or representing a position of a city) can be part of the POI data or can be associated with POI data records. In addition, the map database 108 can include event data (e.g., traffic incidents, construction activities, scheduled events, unscheduled events, etc.) also known as a context associated with the POI data records or other records of the map database 108.

In some embodiments, the map database 108 can include data regarding a plurality of navigational markers located along the road network and an association between each navigational marker and one or more road segments or nodes that the respective navigational marker is located on or near.

In some embodiments, this data may be in the form of navigational marker information within road segment data records and/or node data records. In some embodiments, this data may be in the form of navigational marker data records, where each record includes an identifier of and/or link to one or more road segments and/or one or more nodes. In some embodiments, these navigational marker data records may be equivalent to point of interest data records. All points of interest may be considered to be navigational markers. Alternatively, only POIs which are specifically flagged as navigational markers within their POI data record may be considered to be navigational markers for the purposes of the present disclosure.

Various criteria can be used to determine whether a navigational marker is located on or near a road segment or node and should therefore be associated with that road segment or node. In some embodiments, a distance criterion may be used. For example, a navigational marker may need to be within a certain distance of one or more locations associated with the road segment or node. For this purpose, a node may be associated with a single central location, with four ‘corner’ locations, or with other locations. A road segment may be associated with two end locations, a series of locations forming a polyline, a series of locations forming a straight line between two end points, a mid-point and two quartile points, or with other locations. The certain distance can be different for road segments and for nodes. The certain distance may be a predefined distance common to a plurality of road segments and/or nodes, a predefined distance for a particular road segment and/or node (e.g. the predefined distance depending on the dimensions or type of the particular road segment or node), or a variable distance (e.g. varying depending on the number of potential navigational markers for the node or road segment).

In some embodiments, an address criterion may be used, whereby if an address associated with a navigational marker (e.g. a building, a bus stop, a mailbox, a statue) includes a portion of an address associated with a road segment or a node (e.g. a street name, an intersection name), then the navigational marker may be considered to be associated with that road segment or node. Other factors can be considered. For example, a navigational marker which is located near the end of a road segment may be associated with the node instead of the road segment.

In some embodiments, a navigational marker may only be associated with one road segment or one node. In other embodiments, a navigational marker may be associated with more than one road segment and/or node (e.g. with one road segment and one node, with two road segments, with two road segments and a node). For example, a petrol station that is located at a corner where two roads meet may be associated with a node only, with the node and one or two road segments, with a road segment only or with two road segments.

In some embodiments, the map database 108 can further include data regarding a user perception rating for each of a plurality of road segments and/or data regarding a user perception rating for each of a plurality of nodes. The user perception rating represents a perceptibility to a particular user of the navigational markers along the respective road segment and/or around the respective node as calculated using a user-subjective-navigational-marker-perception profile for the user.

The map database 108 may be maintained by a content provider e.g., a map developer. In some embodiments, the map developer may collect geographic data to generate and enhance the map database 108, whereas in other embodiments, the map database 108 may delegate map generation and revision to other devices, such as mobile device 114. The map developer can use different ways to collect data. One such way includes obtaining data from other sources, such as municipality authorities. Another way is for the map developer to employ field personnel to travel by vehicle along roads throughout the geographic region to observe features and/or record information about them. Another way is using remote sensing, such as aerial or satellite photography, to generate map geometries directly or through machine learning.

A further way is the use of crowd-sourced data from vehicles traveling along the road links in the road network and/or devices located in such vehicles (e.g. mobile device 114). Such vehicles and/or devices may provide information relating to their respective speed of travel, which may provide the map developer with information about traffic volumes, congestion and lane-level paths travelled by the respective vehicles, for example. Such traffic volume, congestion information and lane-level path information may be used during navigation or routing operations.

The map database 108 may be a master map database stored in a format that facilitates updating, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems. For example, geographic data may be compiled (such as into a platform specification format (PSF) format) to organize and/or configure the data for performing navigation-related functions and/or services (such as route calculation, route guidance, map display, speed calculation, distance and travel time functions, and other functions) by a navigation device, such as by mobile device 114. The navigation-related functions can correspond to vehicle navigation, pedestrian navigation or other types of navigation. While example embodiments described herein generally relate to vehicular travel along roads, example embodiments may be implemented for pedestrian travel along walkways, bicycle travel along bike paths, boat travel along maritime navigational routes, etc. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the server side map database 108 may be a master geographic database, but in alternate embodiments, a client side map database 108 may represent a compiled navigation database that may be used in or with end user devices (e.g. mobile device 114) to provide navigation and/or map-related functions. For example, the map database 108 may be used with the mobile device 114 to provide an end user with navigation features. In such a case, the map database 108 can be downloaded or stored on mobile device 114 which can access the map database 108 through a wireless or wired connection, such as via the network 112 and the processing server 102, for example.

FIG. 2 shows one embodiment of an apparatus 200 which may be configured to perform methods described herein. The apparatus 200 includes or is otherwise in communication with a processor 202, a memory device 204, a communication interface 206, and a user interface 208. In this example only one processor 202 and one memory device 204 are shown but it will be appreciated that other examples may utilise more than one processor and/or more than one memory devices (e.g. same or different processor/memory types).

In some embodiments, apparatus 200 may be an example of processing server 102 as shown in FIG. 1. In some embodiments, apparatus 200 may be an example of mobile device 114 as shown in FIG. 1. In other embodiments, apparatus 200 may be a module for a device or circuitry for a device (e.g. processing server 102 or mobile device 114).

The processor 202 (and/or co-processors or any other processing circuitry assisting or otherwise associated with the processor) is in communication with the memory device 204 via a bus for passing information among components of the apparatus 200. The internal connections between the memory device 204 and the processor 202 can be understood to provide active coupling between the processor 202 and the memory device 204 to allow the processor 202 to access computer program code stored on the memory device 204.

The memory device 204 may be non-transitory and may include, for example, one or more volatile and/or non-volatile memories. In other words, for example, the memory device 204 may be an electronic storage device (e.g. a computer-readable storage medium) comprising gates configured to store data (for example, bits) that may be retrievable by a machine (e.g. a computing device like the processor 202). The memory device 204 may be solid-state memory, a hard disk drive (HDD), read-only memory (ROM), random-access memory (ROM), flash memory or another type of memory. The memory device 204 may be configured to store information, data, content, applications, instructions or the like executable by processor 202 for enabling the apparatus to carry out various functions in accordance with an example embodiment of the present disclosure. For example, the memory device 204 could be configured to buffer input data for processing by the processor 202. Additionally or alternatively, the memory device 204 could be configured to store instructions for execution by the processor 202. For example, memory device 204 may be configured to store computer program instructions which, when executed by processor 202, cause apparatus 200 to perform a method as described herein.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an application specific integrated circuit (ASIC), a field programmable gate array (FGPA), a microcontroller unit (MCU), a hardware accelerator, a special-purpose computer chip, or the like. As such, in some embodiments, the processor may include one or more processing cores (of the same or different types) configured to perform independently. A multi-core processor may enable multiprocessing within a single physical package. Additionally or alternatively, the processor 202 may include one or more processors configured in tandem via the bus to enable independent execution of instructions, pipelining and/or multithreading.

In some embodiments, the processor 202 may be configured to execute instructions stored in the memory device 204 or otherwise accessible to the processor 202. Alternatively or additionally, the processor 202 may be configured to execute hard coded functionality. As such, whether configured by hardware or software methods, or by a combination thereof, the processor 202 may represent an entity (for example, physically embodied in circuitry) capable of performing operations according to an embodiment of the present invention while configured accordingly. Thus, for example, when the processor 202 is embodied as an ASIC, FPGA or the like, the processor may be specifically configured hardware for conducting the operations described herein. Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor specific device (for example, a mobile terminal or a fixed computing device) configured to employ an embodiment of the present disclosure by further configuration of the processor by instructions for performing the algorithms and/or operations described herein. The processor 202 may include, among other things, a clock, an arithmetic logic unit (ALU) and logic gates configured to support operation of the processor.

The apparatus 200 may also include a communication interface 206. Communication interface 206 may be any means such as a device or circuitry embodied in either hardware or a combination of hardware and software that is configured to receive and/or transmit data to/from a communications device in communication with the apparatus, such as to facilitate communications with one or more mobile devices 114 or the like. In this regard, the communication interface may include, for example, an antenna (or multiple antennae) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

The apparatus 200 may also include an optional user interface 208 that maybe in communication with the processor 202 to provide output to the user and, in some embodiments, to receive an indication of a user input. As such, the user interface 208 may include a display and, in some embodiments, may also include a keyboard, a mouse, a joystick, a touch screen, touch areas, soft keys, one or more microphones, a plurality of speakers, or other input/output mechanisms. In one embodiment, the processor 202 may comprise user interface circuitry configured to control at least some functions of one or more user interface elements such as a display and, in some embodiments, a plurality of speakers, a ringer, one or more microphones and/or the like. The processor 202 and/or user interface circuitry comprising the processor may be configured to control one or more functions of one or more user interface elements through computer program instructions (for example, software and/or firmware) stored on a memory accessible to the processor 202 (for example, memory device 204, and/or the like). The processor 202 may receive data via the user interface 208 and/or the communications interface 206 and memory device 204 may be configured to store data received via the user interface 208 and/or the communication interface 206.

Route Generation and Route Guidance

As mentioned above, the present disclosure relates to methods, apparatus, and computer program products for identifying a route for a user and providing the route for user navigation.

Routes are typically generated by optimising a driving parameter, e.g. by minimising driving time or distance to generate a fastest route or shortest route. Route guidance can then be generated for the route (independently of the actual calculation of the route). Route guidance is typically given in the form of instructions about maneuvers to be taken when the user is at a particular distance further along the route (e.g. “in 100 metres, turn left”). Advances have been made to provide route guidance that is more similar to the guidance a human would provide, also known as ‘natural guidance’ or ‘natural route guidance’. An example of a natural route guidance instruction is “go straight on past the town hall then turn left after the church”.

However, conventional routes and route guidance do not take into account the differences in how different people see or perceive the world.

Human Visual Perception

Human visual perception involves both the gathering of visual information by the eyes and the processing of this information by the brain. Each of us naturally perceives the world in a different way to each other for a variety of reasons, including physiological differences in our eyes, physiological differences in our brains, psychological factors, environmental factors, conscious and subconscious personal preferences, biases and experiences. Human visual perception can be therefore considered to be ‘subjective’ rather than ‘objective’. Due to our individual perception, every person viewing a single object will perceive it in a different way to how other people perceive it. One person may consider a dress to be white and gold, a second person may see the same dress as blue and black, and a third person may see a different combination of colours, depending on physiological factors, environmental factors, personal preferences and experiences for the two people.

When viewing multiple objects, a person's eye is naturally/instinctively drawn to certain objects before other objects. In other words, a person naturally perceives certain objects before they perceive other objects. This ordering can be different for different people. For example, a first person may look at a landscape (inherently including many objects) and perceive nearby hedgerows before they perceive distant mountains, because the first person naturally perceives nearby objects before they perceive distant objects. A second person might perceive the mountains before they perceive the hedgerow, for example because the second person naturally looks upwards in scenes/towards the top of images, instinctively perceives larger objects before smaller objects, or has an interest in mountaineering. This concept of different people perceiving different things within the same scene/image is commonly employed in optical illusions where two or more objects are shown within a 2D image. Upon seeing the image, people will usually see one object immediately, and only after some time will the one or more other objects become apparent, where the first object can be different for different people.

Human Visual Perception in Navigation

The concept of different people perceiving different things within the same scene/image can be used in navigation, according to embodiments of the present disclosure.

Natural route guidance is given by describing maneuvers with reference to ‘navigational markers’, which are objects located near where the maneuver is to be made. In the example instruction above (“go straight on past the town hall then turn left after the church”), the town hall and church are navigational markers. However, different people looking at a particular road scene may perceive different objects/navigational markers within that road scene, even when the different people are located at the same position, facing in the same direction, and with substantially the same field of view, due to the natural variation in their individual perception characteristics. Furthermore, just because an object/navigational marker is present within a person's field of view, this does not mean that the person will necessarily ‘perceive’ the navigational marker (involving not only the gathering visual information by the eyes but also the processing of this information by the brain).

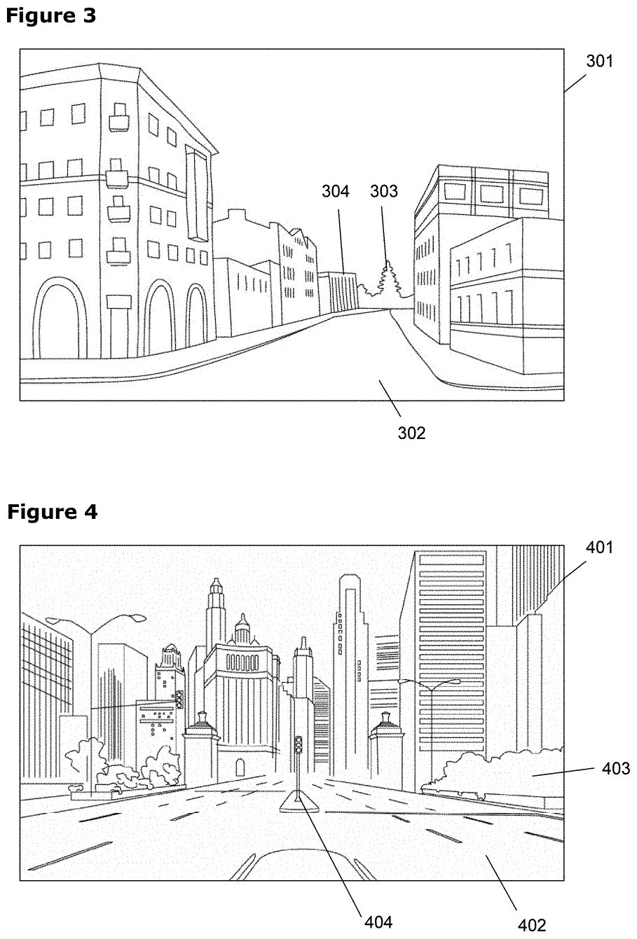

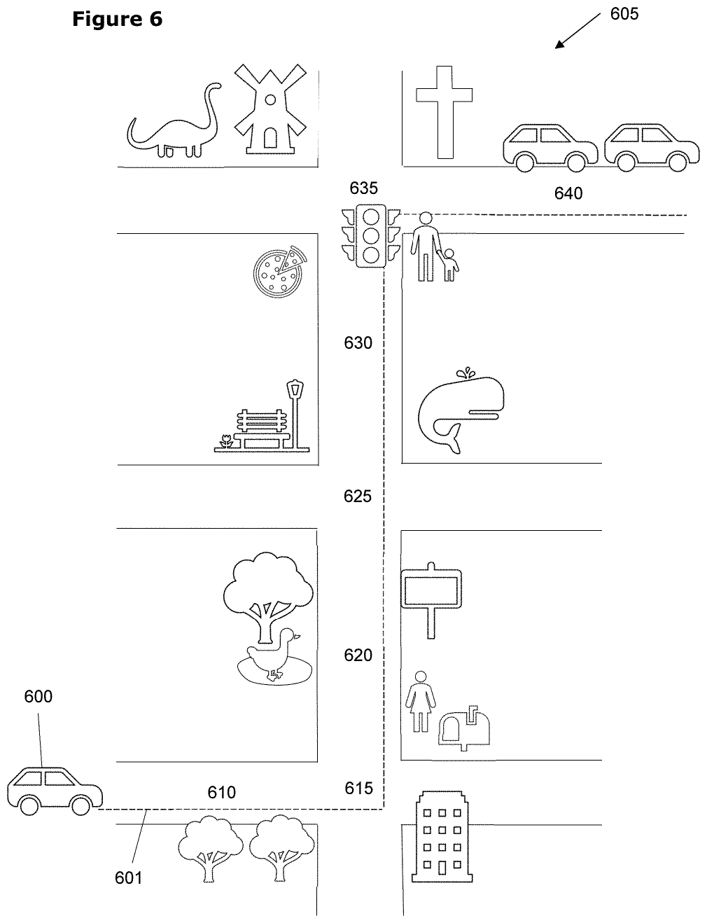

This can be illustrated with reference to FIGS. 3 and 4, each of which shows a schematic road scene image according to respective embodiments of the present disclosure, as well as FIG. 6 which is described further below. In FIG. 3, the schematic image 301 of the road scene shows a road 302, tree 303 and fire station 304. Tree 303 and fire station 304 are examples of navigational markers, that is, objects to which natural route guidance instructions can refer to describe maneuvers. For example, a user following a route along road 302 could be instructed to “turn left after the fire station” or equivalently “turn left before the large tree”.

As discussed above, different people perceive different objects/navigational markers within the same scene. A first person looking at the road scene shown in image 301 may perceive tree 303 before they perceive fire station 304, for example if they naturally disregard buildings as ‘background’ or have a particular interest in nature. A second person may perceive (red) fire station 304 before tree 303, for example if they naturally see red objects before green objects or brighter-coloured objects before darker-coloured objects.

Thus, if the first person were to drive along road 302 and be provided with the route guidance instruction “turn left before the large tree”, they would be likely to visually identify the relevant navigational marker and understand the maneuver instruction more quickly than if they were provided with the instruction “turn left after the fire station”. This would decrease the length of time the first person would take their eyes off the road, allowing them to better concentrate on driving safely. The instruction “turn left before the large tree” can be considered to be more suitable for the first person than “turn left after the fire station”, based on how they personally perceive navigational markers.

The opposite scenario would apply for the second person. The instruction “turn left after the fire station” is more suitable for the second person than “turn left before the large tree”, based on how they personally perceive navigational markers. By providing the more suitable instruction, the second person would be able to identify the navigation marker, understand the maneuver instruction and return their eyes to the road more quickly, potentially reducing the chances of a road accident occurring.

Similarly to FIG. 3, FIG. 4 shows a schematic road scene image 401 according to one embodiment of the present disclosure. The schematic image 401 of the road scene shows a road 402 and two navigational markers, bush 403 and traffic light 404. Different people viewing the road scene shown in image 401 may perceive bush 403 before or after traffic light 404. For example, a first person and a second person may both be driving along road 402. The first person may instinctively perceive objects on the left-hand side of the road before objects on the right-hand side, and therefore perceive traffic light 404 before bush 403. The second person may perceive longer objects (extending in the direction of travel) before tall, thin objects, and therefore perceive bush 403 before traffic light 404.

As for the embodiment of FIG. 3, it is clear that to describe the maneuver of ‘turn left before bush 403 and traffic light 404’, different route guidance instructions are suitable for the first and second persons based on how they personally perceive navigational markers. By personalising/individualising the route guidance instruction for each person, they can each be provided with an instruction for the particular maneuver which allows them to visually identify the relevant navigational marker, understand the instructed maneuver, and return their eyes to the road more quickly and/or more easily than if than if they were provided with a non-personalised route guidance instruction. This may be beneficial for their safety and the safety of others around them on road 402.

Furthermore, it will be appreciated that if the road scene shown in image 401 included traffic light 404 but did not include bush 403, then the navigational markers available for describing the maneuver of turning left before the traffic light 404 would be more suitable for the first person (who perceives left-hand side objects before right-hand side) than the second person (who perceives long objects before tall, thin objects) based on how they personally perceive navigational markers. Thus, this maneuver, as described by natural route guidance, would be quicker and/or easier for the first person to understand and follow than the second person.

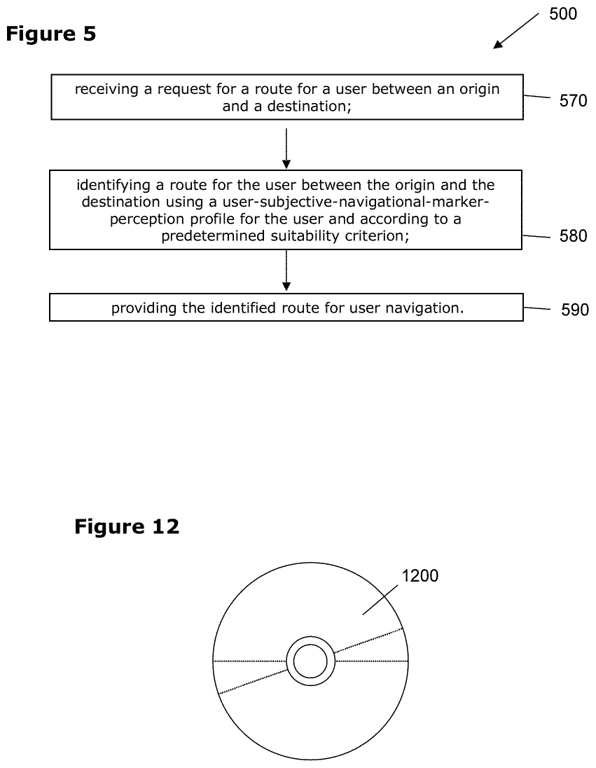

The Method of FIG. 5

FIG. 5 shows the main steps 570-590 of a computer-implemented method 500 described herein. The method 500 comprises: receiving a request for a route for a user between an origin and a destination 570; identifying a route for the user between the origin and the destination using a user-subjective-navigational-marker-perception profile for the user and according to a predetermined suitability criterion 580; and providing the identified route for user navigation 590. Method steps 570-590 are discussed further below.

Method 500 may be performed by various apparatus/entities, including processing server 102 and mobile device 114 as shown in FIG. 1 and apparatus 200 as shown in FIG. 2. In some embodiments, method 500 may be performed by a device located in or on a vehicle, connected to a vehicle and/or integrated with a vehicle (e.g. mobile device 114). A user of the vehicle may request from their in-vehicle device a route between an origin and a destination. The in-vehicle device may identify and provide a suitable route, using a user-subjective-navigational-marker-perception profile for the user (e.g. locally stored or accessed from a remote device, e.g. a map developer processing server 102 or a third party) and optionally using road network data (e.g. locally stored, such as in a map database, or accessed from a remote device, e.g. from map database 108).

In some embodiments, method 500 may be performed by a device associated with the user, also known as an end-user device (e.g. mobile device 114), where the device is not located in/on, connected to or integrated with a vehicle. For example, the user may be at home and request a route for a journey they plan to take the next day. As above, the user-subjective-navigational-marker-perception profile for the user and the optional road network data may be accessed from local or remote storage.

In some embodiments, method 500 may be performed by an apparatus/entity that is remote from a vehicle, for example processing server 102 of map developer system 116. The processing server 102 may receive a request for a route for a user, for example from an end-user device. The processing server 102 may identify and provide (e.g. to the end-user device) a suitable route, using a user-subjective-navigational-marker-perception profile for the user (e.g. stored locally at the map developer system, retrieved from/provided by an end-user device, or stored by a third party) and optionally using road network data (e.g. from map database 108).

In step 570 of method 500, a request for a route for a user between an origin and a destination is received. The request may be directly received from the user via a user interface of the apparatus performing the method 500. The request may not be received from the user, but instead determined and internally transmitted/received by the apparatus performing the method 500. For example, mobile device 114 may determine that based on a calendar appointment, based on a user entering a location, of the like, it may be helpful to provide a route for the user. The request may be received from another device/apparatus (which itself may or may not have received a request directly from the user), e.g. processing server 102 may receive a request from a mobile device 114.

The origin and/or destination may be explicitly specified by the user via a user interface (e.g. user interface 208, such as a touch screen, a keyboard or a microphone). The origin and/or destination may be implicitly specified. For example, the origin may implicitly be taken to be a current location (e.g. a current location of a vehicle, a mobile device 114 and/or an end user's device), a last-entered location, the destination of a previous route, a pre-set location (e.g. ‘home’ or ‘work’), or a location extracted from/associated with a calendar appointment, an email or other message. The destination may implicitly be taken to be a last-entered location, a previously-entered location, a pre-set location (e.g. ‘home’ or ‘work’), or a location extracted from/associated with a calendar appointment, an email or other message. The request, origin and/or destination can also be input by a person who is not the user for whom the route is being requested.

A User-Subjective-Navigational-Marker-Perception Profile

In step 580, a route is identified for the user between the origin and the destination, using a user-subjective-navigational-marker-perception profile for the user and according to a predetermined suitability criterion. The user-subjective-navigational-marker-perception profile for the user comprises data about the user's subjective perception of navigational markers, i.e. data about how the particular user associated with the profile personally/subjectively perceives (or doesn't perceive) different navigation markers and groups thereof. Embodiments of this profile will now be described, before step 580 is described in more detail further below.

Many different objects may be suitable for use as navigational markers, including (but not limited to) one or more of a building, a religious building, a retail building, a gas station, a bus stop, a tram stop, a traffic light, a road sign, a bollard, a bridge, an overpass, a parked vehicle, a non-parked vehicle, a tree, a mailbox, a telephone box, a street lamp, a monument, a bench, a fountain, another item of street furniture, and a pedestrian. Other examples of navigational markers can be envisaged and are within the scope of the present disclosure.

The data about the user's subjective perception of navigational markers can take various forms. In some embodiments, this data comprises one or more perceivable navigational marker attributes, wherein a navigational marker having one of these attributes is considered to be perceivable by the user. In some embodiments, this data comprises one or more unperceivable navigational marker attributes, wherein a navigational marker having one of these attributes is considered to be not perceivable by the user. Some embodiments can involve both perceivable and unperceivable navigational marker attributes. A perceivable navigational marker attribute may refer to an attribute of a category or group of navigational markers that the user typically perceives before they perceive one or more other categories or groups of navigational markers. Conversely, an unperceivable navigational marker attribute may refer to an attribute of a category or group of navigational markers that the user typically perceives after they perceive one or more other categories or groups of navigational markers. The terms ‘after’ and ‘before’ do not necessarily mean first and last perceived in a particular scenario (although they can in some embodiments). Navigational markers that are perceived ‘before’ one or more other categories or groups of navigational markers may be, for example, within the first two or three (or more) navigational markers perceived within a scenario, or any navigational marker perceived within a particular time period (e.g. 2 seconds, 5 seconds).

Thus, in these embodiments, the user-subjective-navigational-marker-perception profile stores information about attributes of navigational markers that the particular user finds particularly perceivable or unperceivable relative to other navigational markers.

Examples of perceivable navigational marker attributes include a colour of navigational marker that the user perceives before other colours of navigational markers, a type of navigational marker that the user perceives before other types of navigational markers, a size of navigational marker that the user perceives before other sizes of navigational marker, a direction relative to a direction of travel along a road segment in which the user perceives navigational markers before other directions relative to a direction of travel, a distance from the user at which the user perceives navigational markers before other distances from the user, whether the user perceives permanent or temporary navigational markers first, and whether the user perceives static or dynamic navigational markers first.

Conversely, examples of unperceivable navigational marker attributes include a colour of navigational marker that the user perceives after other colours of navigational markers, a type of navigational marker that the user perceives after other types of navigational markers, a size of navigational marker that the user perceives after other sizes of navigational marker, a direction relative to a direction of travel along a road segment in which the user perceives navigational markers after other directions relative to a direction of travel, a distance from the user at which the user perceives navigational markers after other distances from the user, whether the user perceives permanent or temporary navigational markers last, and whether the user perceives static or dynamic navigational markers last.

Examples of perceivable and unperceivable navigational marker attributes (and the use thereof) will be discussed with reference to FIG. 6, which shows a portion of a road network 605 according to one embodiment of the present disclosure. The portion of the road network includes road segments 610, 620, 630 and 640, nodes/intersections 615, 625 and 635, and a plurality of navigational markers (represented by icons in FIG. 6). FIG. 6 also shows a vehicle 600 that is currently located on road segment 610 with a planned route 601 through intersection 615, road segment 620, intersection 625, road segment 630, intersection 635, and road segment 640. Route guidance can be provided to the vehicle 600 to assist the driver in following the route 601.

As discussed above in relation to FIGS. 3 and 4, different route guidance instructions are suitable/preferable for different people following this route 601 due to the differences in how different people personally perceive navigational markers (as defined by their user-subjective-navigational-marker-perception profile). Providing a suitable, personalised route guidance instruction for a user for each maneuver, determined using the user-subjective-navigational-marker-perception profile, may allow the user to more quickly and/or more easily visually identify the relevant navigational marker, understand the instructed maneuver, and return their eyes to the road than if they were provided with a non-personalised route guidance instruction for the same maneuver. Additionally, the maneuvers contained within this route 601 may be more or less suitable for different people, depending on the possible route guidance instructions that can be given for these maneuvers. Thus, the route 601 as a whole, from road segment 610 to road segment 640, may be more or less suitable for different people.

For example, when the vehicle 600 is travelling on road segment 610 and approaching intersection 615, various route guidance instructions can be given for the maneuver of turning left on to road segment 620. These include ‘turn left after the two trees’, ‘turn left before the apartment block’, ‘turn left before the pedestrian’, and ‘turn left before the mailbox’. In some embodiments, the route guidance instruction may reference which side of the road a navigational marker is on (e.g. turn left after the two trees on your right), but this is not essential. Each of these route guidance instructions references a different navigational marker having different attributes/characteristics, either inherently or relative to the vehicle 600 located on road segment 610. For example, the two trees are near to the vehicle 600, relatively large, green, permanent and potentially dynamic (in that their leaves may be moving in the wind). The apartment block is large, tall, far away (compared to the two trees), permanent, and static. The pedestrian is small, far away, temporary and dynamic. The mailbox is small, far away, permanent, static and (in this embodiment) blue.

A suitable route guidance instruction for a user can be determined using the user's user-subjective-navigational-marker-perception profile. One user's profile may indicate that they typically perceive nearby objects before far away objects, and therefore the instruction ‘turn left after the two trees’ may be determined to be the most suitable for this user. Another user's profile might indicate that they typically perceive larger objects before smaller objects, and the instruction ‘turn left before the apartment block’ may be most suitable for this user. Another user's profile might indicate that they typically perceive larger objects after smaller objects, i.e. that a large size is an unperceivable navigational attribute for the user, and the instructions ‘turn left before the pedestrian’ or ‘turn left before the mailbox’ would be considered more suitable.

Similar considerations apply for a user approaching the subsequent maneuvers on route 601. For example, when the vehicle 600 is travelling along road segment 620, the route guidance instruction ‘go straight’ can reference three navigational markers —a road sign (right-hand side, relatively high), a tree (left-hand side, relatively tall/high), or a duck pond (left-hand side, low down). One user's user-subjective-navigational-marker-perception profile may indicate that they perceive navigational markers on their right more quickly/easily than navigational markers on their left, and the instruction ‘go straight past the road sign’ may be given. Another user's profile may indicate that they perceive navigational markers high above the ground objects after/less easily than navigational markers close to the ground, and the instruction ‘go straight past the duck pond’ may be given.

Similarly, when the vehicle 600 is approaching intersection 625, the route guidance instructions ‘go straight on past the bench’ or ‘go straight on past the aquarium’ may be given. A user's user-subjective-navigational-marker-perception profile may indicate that they quickly/easily (or slowly/with difficulty) perceive street furniture in general, benches specifically, or large buildings. Based on these perceivable (or unperceivable) navigational marker attributes, a suitable route guidance instruction can be chosen for the user.

Similarly, when the vehicle 600 is travelling along road segment 630 and approaching intersection 635, the route guidance instruction ‘turn right can be given with a reference to a pedestrian and child, a traffic light, a pizza restaurant, a windmill or a church. A user's user-subjective-navigational-marker-perception profile may indicate that they perceive navigational markers which are temporary (e.g. a pedestrian) before those that are permanent (e.g. a windmill or church), navigational markers which are dynamic (e.g. a windmill or pedestrian) before those that are static (e.g. a church or pizza restaurant), a particular type of navigational marker (e.g. a church, restaurant, buildings in general, a traffic light, street furniture in general) before others, large navigational markers (e.g. a windmill or church) before those that are small (e.g. a pedestrian or traffic light), navigational markers which are nearer (e.g. a traffic light, pedestrian or pizza restaurant) before those that are further away (e.g. a windmill or, church). Based on these perceivable navigational marker attributes (or any other perceivable or unperceivable navigational marker attributes present in the user-subjective-navigational-marker-perception profile), a suitable route guidance instruction can be chosen for the user.

Finally, once the vehicle has turned on to road segment 640, they may be provided with the instruction ‘go straight past the silver car’ or ‘go straight past the red car’, depending on what information the user-subjective-navigational-marker-perception profile gives about colours the user finds perceivable or unperceivable relative to others. For example, a particular user may find that, for them, the colour silver blends into the road surface whereas the colour red usually stands out, and so this user would be given the instruction ‘go straight past the red car’.

In some embodiments, the data about the user's subjective perception of navigational markers (contained in a user-subjective-navigational-marker-perception profile) may further comprise a perceptibility ranking of perceivable navigational marker attributes and/or unperceivable navigational marker attributes. A navigational marker having a higher-ranked attribute (whether a perceivable or unperceivable attribute) is considered to be more perceivable by the user than a navigational marker having a lower-ranked attribute. For example, the user-subjective-navigational-marker-perception profile may indicate that ‘red’, ‘green’ and ‘dynamic’ are all perceivable navigational marker attributes and ‘temporary’, ‘small’ or ‘distant’ are all unperceivable navigational marker attributes. The profile may further indicate a perceptibility ranking of ‘red’, ‘green’, ‘dynamic’, ‘temporary’, ‘small’ and ‘distant’, where red navigational markers are considered the most perceivable and distant navigational markers the least perceivable. Other attributes that are not mentioned may be implicitly ranked below all specified perceivable navigational marker attributes and above all unperceivable navigational marker attributes.

In some embodiments, the data about the user's subjective perception of navigational markers (contained in a user-subjective-navigational-marker-perception profile) may be valid in all weather conditions, all types of geographic area, and at all times of the day and year. In other embodiments, the user-subjective-navigational-marker-perception profile may comprise data about the user's subjective perception of navigational markers in one or more particular weather conditions, in one or more particular types of geographic area, at one or more particular times of day, in one or more particular months of the year, and/or in one or more particular seasons of the year.

For example, in most weather conditions, a user may find distant navigational markers to be more perceivable than closer navigational markers, whereas in rainy, snowy or foggy weather the reverse may be true. In rural areas, the user may find buildings particularly perceivable whereas in urban areas, the user may find trees or other vegetation perceivable and all types of buildings unperceivable. Around sunrise each day, a user may find navigational markers located to the east of their route to be unperceivable due to the glare of the sun whereas around sunset the user may find navigational markers to the west of their route to be unperceivable. In the spring/summer (or in defined spring/summer months), green may be an unperceivable navigational attribute because green navigational markers (e.g. a green car, a green storefront) do not stand out against the abundance of green vegetation.

Identifying a Route

In step 580 of method 500, a route for a user between the origin and the destination is identified, using a user-subjective-navigational-marker-perception profile for the user and according to a predetermined suitability criterion. As discussed above, the user-subjective-navigational-marker-perception profile comprises data about the user's subjective perception of navigational markers. The identified route includes navigational markers along the route which are flagged based on the profile.

Method step 580 can identify a route that is most perceptibility-suitable for the particular user, i.e. the route that has navigational markers that the user is most likely to perceive. Different routes between the same origin and destination can be identified for different users, given their different perception profiles. As discussed above, route guidance referring to perceivable navigational markers is easier for a user to follow, and also safer as the user spends less time looking for the navigation marker rather than concentrating on driving safely. Thus, identifying and providing a personalised perceptibility-suitable route for a user (or multiple users) may have positive effects on road safety.

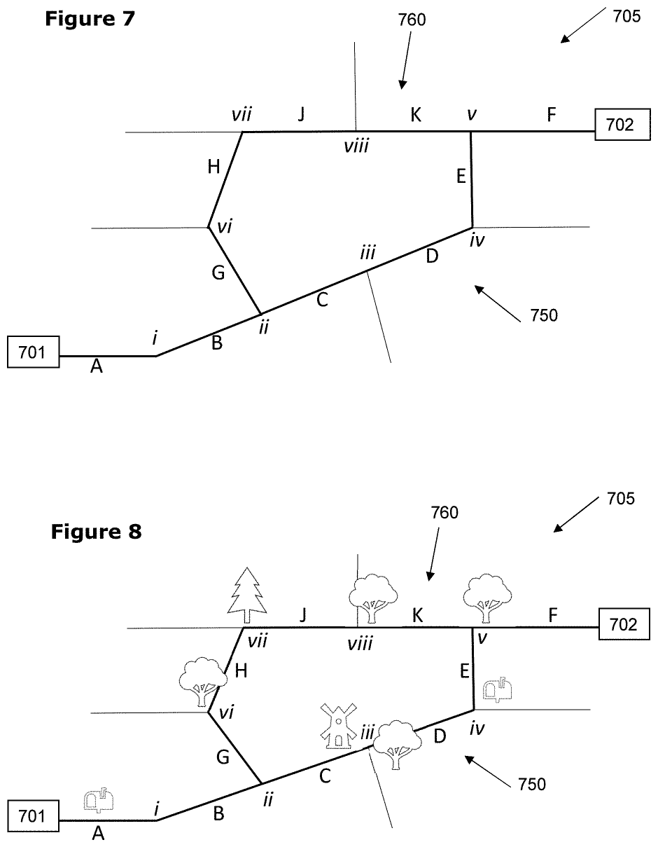

The route may be identified in various ways. In some embodiments, identifying such a route comprises selecting one of a plurality of pre-calculated routes for the user between the origin and the destination. For example, a map developer may have calculated and stored many routes between many multiple origin/destination pairs prior to the request for a route for the user. This may be done for popular/frequently travelled routes, e.g. from a city to a popular out-of-town tourist destination, to avoid frequently recalculating these routes for users. In other examples, a map developer may calculate multiple routes from an origin to a destination upon receiving a request for such routes. These multiple routes may be sent to a mobile device (or a third party) where the user-subjective-navigational-marker-perception profile is stored and can be used to identify a suitable route from the multiple routes. Selecting one of a plurality of pre-calculated routes may involve reviewing the attributes pre-associated with one or more pre-calculated route. Selecting one of a plurality of pre-calculated routes may involve calculating a user perception rating for each pre-calculated route. In other embodiments, identifying such a route may comprise calculating a route for the user between the origin and the destination using road network data. These embodiments are described further below with reference to FIGS. 7 and 8.

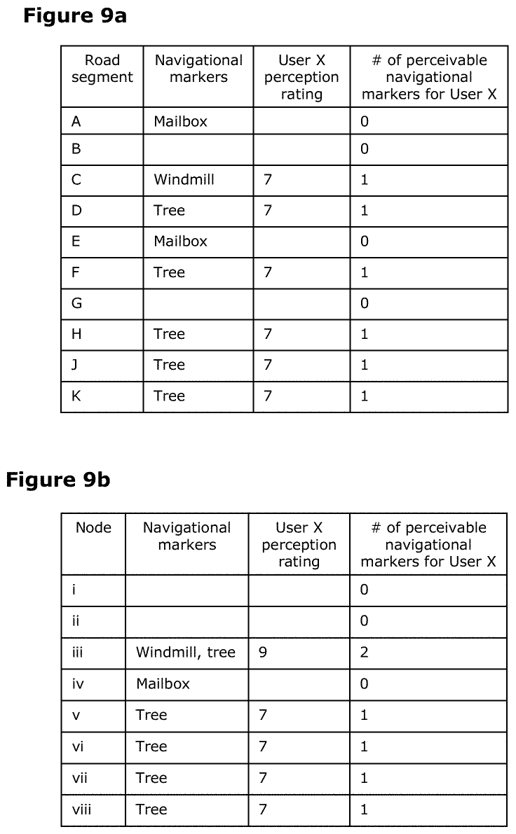

FIG. 7 shows a portion of a road network 705 according to one embodiment of the present disclosure. The portion of the road network includes road segments A, B, C, D, E, F, G, H, J and K, and nodes/intersections i, ii, iii, iv, v, vi, vii and viii. FIG. 8 shows the portion of the road network 705 and additionally a plurality of navigational markers (represented by icons). A mailbox is present on road segment A, a second mailbox on road segment E at intersection iv, a windmill on road segment C near intersection iii, and five trees at intersections iii, v, vi, vii, viii on road segments D, F, H, J and K (as shown in FIGS. 9a and 9b).

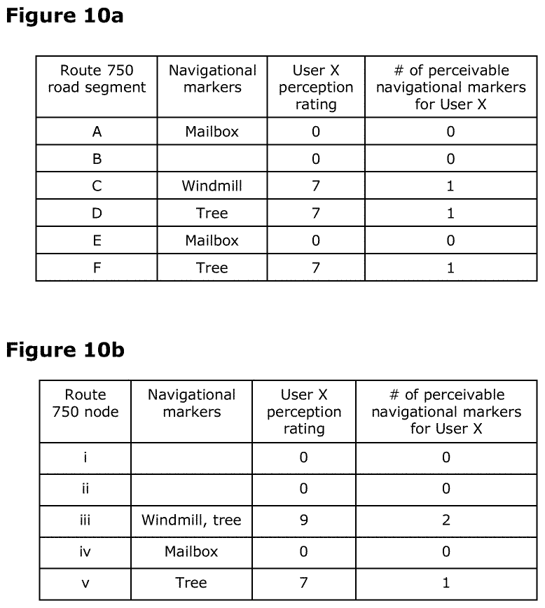

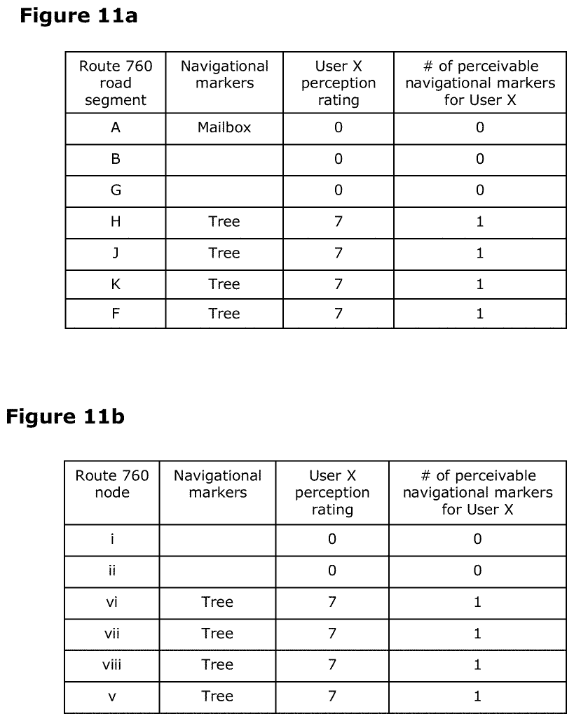

Both FIGS. 7 and 8 show an origin 701, a destination 702, and two pre-calculated routes 750, 760 between the origin 701 and the destination 702 (indicated by road segments with heavier lines). Route 750 comprises road segment A, intersection i, road segment B, intersection ii, road segment C, intersection iii, road segment D, intersection iv, road segment E, intersection v, and road segment F. Route 760 comprises road segment A, intersection i, road segment B, intersection ii, road segment G, intersection vi, road segment H, intersection vii, road segment J, intersection viii, road segment K, intersection v, and road segment F. The navigational markers located along route 750 are two mailboxes, a windmill and two trees (as shown in FIGS. 10a and 10b). The navigational markers located along route 760 are one mailbox and four trees (as shown in FIGS. 11a and 11b).

Selecting from a Plurality of Pre-Calculated Routes with Associated Attributes

In some embodiments, one or more of pre-calculated routes 750, 760 may have an associated attribute (or more than one attribute) describing a category of navigational marker located along the respective routes. This attribute may have been associated with the respective route by a map developer. For example, route 760 may be associated with a ‘tree’ attribute, as this is the dominant navigational marker along the route. This indicates that route 760 may be a suitable route for users who find trees perceivable. It may or may not indicate that route 760 is an unsuitable route for users who find trees unperceivable, e.g. route 760 may additionally be associated with another attribute describing navigational markers that such users do find perceivable. Route 750 may be associated with an attribute such as a ‘tree’, ‘mailbox’, ‘small markers’, ‘dynamic’. Route 750 may be associated with a ‘mixed’ attribute indicating that a variety of navigational markers are located along the route and that no particular categories are dominant. Alternatively, route 750 may not be associated with any attribute.

Optionally, routes may have a weighting for their associate attribute. For example, both routes 750 and 760 may be associated with a ‘tree’ attribute. This may have a ‘strong’, ‘high’ or similar weighting for route 760, indicating that there are a significant number of tree navigational markers located along route 760. Route 750 may have a ‘weak’, low′ or similar weighting for route 750, reflecting that whilst there are trees along the route, there are a relatively low number compared to route 760.

Identifying a route for the user between the origin and the destination may comprise firstly comparing the one or more attributes associated with the one or more routes to the user-subjective-navigational-marker-perception profile. Secondly, one of the plurality of pre-calculated routes is selected based, at least in part, on the comparison. The comparison and selection steps may take into account routes having multiple attributes, routes having no attributes, route attribute weightings, and other factors relevant for selecting a route, e.g. respective route distances and travel times.

For example, the ‘tree’ attribute of route 750 may be compared to any relevant parts of a user-subjective-navigational-marker-perception profile for User X, such as any perceivable or unperceivable attributes relating to trees, vegetation, or the colour green. The comparison may indicate that (based solely on this attribute of the route), route 750 is suitable for User X. The ‘tree’ attribute of route 760 may also be compared to these parts of the user-subjective-navigational-marker-perception profile, with the comparison again indicate that route 760 is suitable for User X (potentially less so than route 750 if a weighting factor is used). However, the profile may indicate that User X finds small objects unperceivable. When this part of the profile is compared to the ‘mailbox’ attribute of 750, this may indicate that route 750 is less suitable for User X. Taking these comparisons as a whole, route 760 may be selected because its associated attributes indicates that it is more suitable for User X than route 750. Alternatively, the selection may be based on the route distances and travel times as well as on these comparisons. The combination of a weak ‘tree’ attribute (perceivable) and the shorter route distance/travel time for route 750 may be more dominant than the strong ‘tree’ attribute (perceivable) of route 760 and the ‘mailbox’ attribute (unperceivable) of route 750, leading route 750 to be selected.

In these embodiments, the predetermined suitability criterion is that the identified route must be associated with an attribute that is sufficiently perceivable by the user according to their user-subjective-navigational-marker-perception profile.

Calculating a User Perception Rating for a Plurality of Pre-Calculated Routes

In other embodiments, identifying a route for the user between the origin and the destination may comprise calculating a user perception rating for each of the plurality of pre-calculated routes using road network data for a geographic area including the origin and destination and the user-subjective-navigational-marker-perception profile. Secondly, one of the plurality of pre-calculated routes is selected based, at least in part, on the user perception ratings.

The road network data may be accessed from local storage (part of or directly connected to the apparatus/entity performing method step 580) or from remote storage. The road network data may be stored at map database 108 in map developer system 116, memory device 204 in apparatus 200, or a memory of mobile device 114, for example. The accessed road network includes road segment data, node data, a plurality of navigational markers located along the road network, and an association between each navigational marker and one or more road segments or nodes that the respective navigational marker is located on or near.

The user perception rating is a representative value for each route which allows multiple routes to be compared to determine a most suitable route. The user perception rating for each pre-calculated route represents a perceptibility to the user of the navigational markers along the road segments of the respective route. The rating can take a numerical value, such as from 1 to 5, 0 to 10, 1 to 100, 1% to 100%, or a descriptive value, such as low, medium and high levels of perceptibility. It can be calculated using a variety of criteria, as will be described further below with reference to FIGS. 9a, 9b, 10a, 10b, 11a and 11b.

FIG. 9a shows a table relating to the road segments A-K in the portion of the road network 705 in FIG. 7. The first column shows the road segments A-K. The second column shows the navigational markers associated with (i.e. located on or sufficiently near) each road segment. The third column shows an optional user perception rating for each road segment (discussed further below) for User X. The fourth column shows the number of perceivable navigational markers for User X for each road segment. As previously mentioned, User X's user-subjective-navigational-markers-perception profile includes ‘trees’ as a perceivable navigational marker attribute and ‘small’ as an unperceivable navigational marker attribute. ‘Buildings’ are also a perceivable navigational marker attribute for User X, according to their profile. Thus, the five trees and one windmill are considered to be perceivable navigational markers for User X, whereas the two mailboxes are considered unperceivable.

FIG. 9b shows a similar table for the nodes i-viii in the portion of the road network 705 in FIG. 7. FIGS. 10a and 10b show similar tables to FIGS. 9a and 9b, limited to the road segments and nodes included in route 750. FIGS. 11a and 11b show similar tables the route segment and nodes for route 760. Thus, the fourth columns in FIGS. 10a, 10b, 11a and 11b show the number of perceivable navigational markers for User X for each road segment or node for routes 750, 760, according to User X's user-subjective-navigational-marker-perception profile.

The user perception rating can be calculated based on at least one (or a combination of) of the following example criteria. Each criterion is described using routes 750 and 760 as examples, with the threshold of 0.5 navigational markers, and a rating scale from 0 (very poor perceptibility) to 10 (very good perceptibility). Each of these criteria uses both road network data (e.g. to assess where navigational markers are located on the route) and the user-subjective-navigational-marker-perception profile (to determine perceivable navigational markers for the user). Other criteria can be envisaged and are within the scope of the present disclosure.

Firstly, the number of road segments of the route that are associated with more than a threshold number of navigational markers that are perceivable by the user. For route 750, 3 (out of 6) road segments are associated with more than 0.5 (i.e. one or more) perceivable navigational markers (as indicated by FIG. 10a, fourth column) whereas for route 760 this is 3 (out of 7) (FIG. 11a, fourth column). Because both routes have the same number of road segments with more than the threshold number of perceivable navigational markers, a user perception rating based on this criterion alone would be the same for both routes, e.g. 5 out of 10.

Secondly, the number of road segments of the route that are associated with fewer than a threshold number of navigation markers that are perceivable by the user. For route 750, this number is 3 (out of 6) road segments, whereas for route 760 it is 4 (out of 7). According to this criterion, route 760 has worse perceptibility for User X, so would have a lower user perception rating than route 750.

Thirdly and fourthly, the number of nodes of the route that are associated with more than or fewer than a threshold number of navigational markers that are perceivable by the user. For route 750, 2 out of 5 nodes have a perceivable navigational marker, whereas for route 760, 4 out of 6 nodes do (as indicated by FIGS. 10b and 11b respectively). Whichever node criterion is used, route 760 receives a high user perception rating for User X than route 750.

Next, the number of maneuvers in the route that are associated with more than or fewer than a threshold number of navigational markers that are perceivable by the user. This number of maneuvers may be the same as the corresponding number of road segments or nodes, if there is considered to be a maneuver when the route passes through every road segment or node. In other examples, only turns may be considered maneuvers, not continuing straight along a road. Both routes 750 and 760 involve two turns and each has a perceivable navigational marker at one of these intersections. Thus a user perception rating based on this criterion alone would be the same for both routes.

Other criteria are a total distance along the route that is associated with more than or fewer than a threshold number of navigational markers that are perceivable by the user. This could be calculated by summing the lengths of road segments that are or are not associated with perceivable navigational markers.

Another criterion is a maximum single distance along the route that is associated with fewer than a threshold number of navigational markers. For route 760, this maximum single distance is the sum of the lengths of road segments A, B and G. For route 750, this may be considered to be the sum of the lengths of road segments A and B only, or the sum of the lengths of road segments A, B and the portion of C leading up to the windmill navigational marker. As route 750 involves a shorter distance with no perceivable navigational markers than route 760, route 750 would receive the high user perceptibility rating based on this criterion alone.

Other criteria are the proportion of the route that is associated with more than or fewer than a threshold number of navigational markers that are perceivable by the user. This may be measured in various ways, for example, the number of road segments of the route associated with more than or fewer than the threshold number of navigational markers divided by the total number of road segments. Alternatively, the number of nodes or the total distance associated with more/fewer than the threshold number of navigational markers can be used. These criteria would give route 760 a higher user perception rating than route 750.

Once a user perception rating has been calculated for each of the pre-calculated routes, one pre-calculated route can be selected based on the user perception ratings. In some embodiments, the selection can additionally be based on other factors, for example route distance or travel time. Thus, a route that achieves an optimal combination of user perceptibility and distance and/or speed can be selected. The route with the highest user perception rating is not necessarily chosen if it is significantly slower and/or longer than other routes with reasonably high user perception ratings.

The examples described above use 0.5 as a threshold number of navigational markers. In other examples, other threshold numbers can be used. The threshold number can be predefined (e.g. a default value, a user-set value) or variable, e.g. higher thresholds may be used in geographic areas with larger numbers of navigational markers (e.g. urban areas) than geographic areas with smaller numbers of navigational markers (e.g. rural areas.

In these embodiments, the predetermined suitability criterion is that the identified route must have a sufficiently high user perceptibility rating as calculated using the user's user-subjective-navigational-marker-perception profile.

Calculating a Route

Rather than selecting one from a plurality of pre-calculated routes, in some embodiments identifying a route for the user between the origin and the destination comprises calculating a route for the user between the origin and the destination using road network data and the user-subjective-navigational-marker-perception profile by maximising a user perception rating for the route.

As above, the road network data may be accessed from local storage (part of or directly connected to the apparatus/entity performing method step 580) or from remote storage. The road network data may be stored at map database 108 in map developer system 116, memory device 204 in apparatus 200, or a memory of mobile device 114, for example. The accessed road network includes road segment data, node data, a plurality of navigational markers located along the road network, and an association between each navigational marker and one or more road segments or nodes that the respective navigational marker is located on or near.

As above, a user perception rating for a route is a representative value for the route which allows multiple routes (or portions thereof) to be compared. The user perception rating for a route represents a perceptibility to the user of the navigational markers along the road segments of the respective route. The user perception rating can take a numerical or descriptive value. The user perception rating can be calculated using a variety of criteria, including the criteria set out in the previous section.

A route can be calculated using conventional route generations algorithms (e.g. Dijkstra's algorithm, A* algorithm), with a user perception rating as a cost to maximise. Multiple branching routes on the road network can be explored, and branches which appear unlikely to lead to routes to the destination with a suitably high user perception rating can be pruned. For example, branches that have already exceeded a threshold number of road segments with no perceivable road segments may be pruned. In other examples, branches with a low proportion of route segments associated with perceivable navigational markers may be pruned, or branches that have already exceeded a single distance with no perceivable road segments may be pruned.

In some embodiments, user perception rating may not be the only cost considered. For example, travel time and/or distance may also be costs to be minimised. User perception rating and travel time and/or distance may be given equal or unequal weightings. In some examples, the route generation algorithm may search for a route that primarily has a high user perceptibility rating, with travel time and/or distance as a secondary factor used to ‘choose between’ potential routes with similarly high user perceptibility ratings.

In these embodiments, the predetermined suitability criterion is that the identified route must have a sufficiently high user perceptibility rating as calculated using the user's user-subjective-navigational-marker-perception profile.

Identifying a Route—Additional Optional Features

The methods above use road network data to determine what navigational markers are located on or near road segments and/or nodes of a pre-calculated route or a route being calculated, in order to assess how suitable a route may be for a user. Information about navigational markers located on or near road segments and/or nodes can also be obtained from one or more sensors located (permanently or temporarily) along road segments of the road network, for example a CCTV camera, a camera located on a probe vehicle, or a LIDAR device located on a probe vehicle. This allows navigational markers which are temporarily present (e.g. scaffolding present during building renovations, a cherry blossom tree identifiable during the spring, a Christmas tree present during December) to be used for route identification and navigation. The apparatus performing identifying step 580 can receive (directly or indirectly from the sensors) sensor data which includes the locations of one or more detected navigational markers along one or more road segments of the road network. Identifying the route for the user between the origin and the destination (including using any of the methods described above) can use the locations of the one or more detected navigational markers.

In some examples, the received sensor data may include an identification of the detected navigational marker, e.g. a processor at a CCTV camera may have identified that the data from the camera feed shows a parked large blue truck. In other examples, the received data may not include such an identification. Instead, the data may be raw unanalysed data, and the apparatus (e.g. processing server 102 of map developer system 116) may subsequently analyse it to determine that it shows a parked large blue truck.

In some examples, the sensor data can explicitly include a location of an identified navigation marker. In some examples, the sensor data can explicitly include the location of the sensor, with the locations of the detected navigational markers being taken to be the location of the sensor or calculated from the location of the sensor (e.g. estimated to be on the other side of the road segment from the sensor, 20 metres along the road segment from the sensor). In other examples, the sensor data may not include an explicit location. Instead, the location of the particular sensor may already be known at (or be obtainable by) the apparatus receiving the sensor data, meaning that this location is implicit in sensor data sent by the particular sensor.

Several of the methods described above use a user perception rating for a route (pre-calculated or currently being calculated) that is calculated using road network data and the user-subjective-navigational-marker-perception profile for the user. Optionally, the accessed road network data may comprise a user perception rating for each of a plurality of road segments and/or nodes. The user perception rating for each road segment or node represents a perceptibility to the user of the navigational markers along the respective road segment or around the respective node, as calculated using the user's user-subjective-navigational-marker-perception profile. This allows road network data to be ‘personalised’ using the user's perception profile, in advance of any particular routes being requested, such that the road network data itself includes ratings for how perceivable the user finds navigational markers on each road segment/at each node. This may be (but is not necessarily) done at a user's end device (e.g. mobile device 114) having locally-stored road network data. FIGS. 9a-11b, third columns, show examples of user perception ratings for individual road segments and nodes for the road network 705 shown in FIG. 7, on a scale of 0 (very poor perception) to 10 (very good perception).

A previous section lists example criteria which can be used to calculate a user perception rating for a route. Alternatively or additionally, the user perception rating for a route may be calculated using the user perception ratings for the road segments and/or nodes forming the route. For example, the user perception rating for a route may be an average (e.g. a mean or median) or a sum of the user perception ratings for the road segments and/or nodes forming the route. The user perception rating for a route may be an average (e.g. a mean or median) or a sum of the user perception ratings for the road segments and/or nodes at which maneuvers are to be taken on the route (e.g. turns only). The example criteria listed above could consider a threshold user perception rating rather than a threshold number of perceivable navigational markers. For example, the user perception rating for a route could be calculated based (at least in part) on the proportion of road segments that have a user perception rating above a threshold, or the number of nodes that have a user perception rating below the threshold.

Flagged Navigational Markers

In addition to the road segments and/or nodes forming the route, the identified route also includes navigational markers along the route which are flagged based on the user-subjective-navigational-marker-perception profile. For example, the identified route may include a list of identifiers for navigational markers along with an indication that they are flagged (where the indication can be explicit for each navigational marker individually, explicit for the entire list, or implicit by virtue of these navigational markers being present in a particular list).

Navigational markers can be positively flagged or negatively flagged. A positive flag may indicate that route guidance for the identified route can refer to this navigational marker. In some examples, a positive flag may indicate that the route guidance should refer to this navigational marker. In some examples, route guidance may only refer to positively flagged navigational markers. In other examples, route guidance can also refer to non-flagged navigational markers. In some examples, a negative flag may indicate that the route guidance cannot refer to this navigational marker. In other examples, it may indicate that ideally it should not refer to the navigational marker (but potentially if there are no other positively or non-flagged navigational markers nearby, route guidance referring to a negatively flagged navigational marker may still be given). In some embodiments, an identified route can include both positively-flagged navigational markers and negatively-flagged navigational markers. In other embodiments, an identified route may include only positively-flagged navigational markers or negatively-flagged navigational markers.

For routes 750 shown in FIG. 8, the windmill and two tree navigational markers may be positively flagged, and the two mailbox navigational markers may be negatively flagged or not flagged. Similarly for route 760, the four tree navigational markers may be positively flagged and the one mailbox negatively flagged or not flagged. This may indicate that the four tree navigational markers can (or should definitely) be used in route guidance, and that ideally the mailbox navigational marker would not be used.

Providing the Route

In step 590 of method 500, the identified route is provided for route navigation. Providing the identified route may comprise providing the route to a user, for example providing the route visually on a display or audibly. Providing the identified route may comprise providing the route from one apparatus to another apparatus, such as from an apparatus which identified the route to an apparatus at which route navigation will be performed. For example, the route may be provided from processing server 102 to mobile device 114. In another example, the route may be provided from a driver's mobile phone to their in-vehicle navigation system. Providing the identified route may comprise providing internally within an apparatus, e.g. between a route identification module of mobile device 114 and a route navigation module of mobile device 114.

In some embodiments, detailed route guidance instructions for the route can be provided in addition to providing the identified route with flagged navigational markers. In some embodiments, a user perception rating for the route can be provided.

Earlier in the description, it is noted that embodiments described herein may be implemented in autonomous, semi-autonomous, or non-autonomous vehicles. It will be appreciated that the concept of using a user-subjective-navigational-marker-perception to identify a route having navigational markers that are perceivable to the user is still relevant to autonomous vehicles, as well as semi-autonomous and non-autonomous vehicles. For example, a person travelling in an autonomous vehicle may want to know the route that will be taken so that they are not surprised by sudden movements of the vehicle. Thus, the route including navigational markers may be provided to the person, such as displayed on a screen of their mobile device.

Identifying a route for an autonomous vehicle with navigational markers which are perceivable by the person may make the autonomous vehicle's route easier to follow, increasing the person's confidence in (and comfort in) the autonomous vehicle.

Generating the User-Subjective-Navigational-Marker-Perception Profile

As discussed above, the user-subjective-navigational-marker-perception profile for the user comprises data about how the particular user associated with the profile personally/subjectively perceives (or doesn't perceive) different navigation markers and groups thereof.

A user-subjective-navigational-marker-perception profile can be generated in various ways. In some embodiments, a user may input information about attributes of navigational markers that they believe they do or do not easily/quickly perceive in road scenes. For example, a user may provide input stating that she knows she struggles to see mailboxes and telephone boxes but does see churches and is happy to receive route guidance which references churches. This information can be stored in this user's user-subjective-navigational-marker-perception profile, for example ‘church’ may be stored as a perceivable navigational attribute and ‘mailbox’ and ‘telephone box’ may be stored as unperceivable navigational attributes.

In other embodiments, a user may be provided with a plurality of road scene images, each road scene image including two or more navigational markers and each navigational marker having one or more associated attributes. For example, road scene images 301 and 401 could be provided to the user. Image 301 includes a tree 303 and fire station 304, where tree 303 may have the attributes ‘green’, ‘tree’, ‘vegetation’, ‘large’ and ‘straight ahead’, and fire station 304 may have the attributes ‘red’, ‘building’, ‘large’, ‘left hand side’ and ‘static’.

For each of the plurality of road scene images, the user is asked to provide an input indicating one or more navigational markers that the user perceives before other navigational markers. In some examples, the user input may be received via one or more of a gaze-tracking device, a microphone, a touchscreen, a touchpad, and a mouse. In some examples, the user may be prompted to choose navigational markers that relate to a specific maneuver, e.g. by circling an area on the road scene in which the user is to focus or by describing the maneuver, e.g. ‘turn left’, whereas in other examples the user may be free to choose from anywhere in the image. The user may be given a time limit in which to perceive navigational markers, e.g. each road scene image may be presented for 5 seconds only. The user may be asked to indicate the order in which they perceive multiple navigational markers. For example, for image 301 the user may be asked to indicate the navigational markers they perceive towards the end of road 302 within a 5 second time limit, and the user may indicate that they see fire station 304 first, followed by tree 303.

Data about the user's subjective perception of navigational markers is stored in a user-subjective-navigational-marker-perception profile for the user based on the received input from the user about the plurality of road scene images. The received user input can translate to stored profile data in various ways. For example, after receiving user input for road scene image 301 as discussed above, ‘red building may be stored as a perceivable navigational attribute. ‘Tree’ may also be stored as a perceivable navigational attribute because tree 303 has also been perceived by the user (before other navigational markers in that area of the image, if not first). In some examples, ‘tree’ may be given a lower weighting than the ‘red building attribute because it was perceived second. In some examples, the reaction time of the user in perceiving a navigational marker (e.g. the period elapsing between the image being shown and the user's gaze being directed to the navigational marker as detected by a gaze tracker) may influence a weighting given to a perceivable navigational attribute. In other examples, ‘tree’ may not be stored as a perceivable navigational attribute because it was not the first perceived navigational marker.

User input for multiple road scene images can be combined to give additional insights. For example, if the user did not perceive and identify tree 303 in image 301, this may not be enough to store ‘tree’ as an unperceivable navigational attribute. However if the user also did not perceive bush 403 in image 401 within the 5 second time limit, then this may indicate that the user has a problem with perceiving vegetation in general, and ‘vegetation’ may be stored as an unperceivable navigational attribute. Similarly, if for a third image, the user perceived and identified a red navigational marker (e.g. a red telephone box or red car) but not a green navigational marker (e.g. a green car), then ‘red’ may be stored as a perceivable navigational attribute (in view of the perceived red fire station 304) and ‘green’ as an unperceivable navigation attribute (in view of the unperceived green tree 303 and bush 403). These perceivable/unperceivable navigational attributes may be given a low weighting as they are drawn from at most three images. The more images that contribute towards the determination of a perceivable/unperceivable navigational attribute, the higher its weighting may be.

In some embodiments, the providing and receiving user input about the plurality of road scene images steps is part of a user training a machine learning algorithm. Machine learning algorithms can be used to extract information about the types of navigational markers the user does or does not perceive. Machine learning algorithms can also be used to determine which road scene images to provide to the user for user input, e.g. by determining navigational marker attributes for which user input is lacking or ambiguous.

Preferably, the user is provided with a large enough number of road scene images for reasonably reliable data about the user's subjective perception of navigational markers to be extracted, for example at least 5, 10, 20 or 50 road scene images. Preferably, the provided road scene images include a wide range of navigational markers having a wide range of navigational marker attributes.

In some embodiments, a confidence level may be associated with a user-subjective-navigational-marker-perception profile to reflect a confidence in the accuracy of the data about the user's subjective perception of navigational markers. In some embodiments, particular parts of the profile (e.g. particular navigational attributes) may have respective associated confidence levels. A route identified using the user-subjective-navigational-marker-perception profile may similarly be associated with a confidence level, either the confidence value for the profile as a whole or a confidence level depending on the particular parts of the profile used to identify the route. Generally speaking, the more training images that have been used to generate the user-subjective-navigational-marker-perception profile (or a particular part thereof), the higher the confidence level. For example, if only 10 training images were used to generate the profile, there may be a 20% confidence that a route identified using this profile really will include suitable/perceivable navigational markers for the user, whereas if 50 training images have been used, the confidence level may be 85%. If only 2 images were used to determine ‘red’ as a perceivable navigational marker, this may have a 30% confidence level whereas if 10 images had been used, the confidence level might be 90%. A confidence level for the identified route may be provided (e.g. to the user) with the route.

In some embodiments, the methods used to generate a user-subjective-navigational-marker-perception profile can also be used to address parts of an identified route which do not include many (or any) perceivable navigational markers. For example, once a route has been identified, it may be noted that a road segment, node or maneuver is associated with fewer than a threshold number of perceivable navigational markers.

This may be because the navigational markers that are known to be present at this road segment, node or maneuver are associated with unperceivable navigational marker attributes for the user (e.g. at node iv on route 750 in FIG. 8). Alternatively, this may be because the road network data used to calculate the route does not include any navigational markers at this road segment, node or maneuver (e.g. at node ii on route 760 in FIG. 8). Either way, it may be difficult to provide route guidance for this road segment, node or maneuver.

To address this issue, the user can be provided with a road scene image for the identified road segment, node or maneuver, the image including multiple navigational markers. The user then provides input indicating one or more navigational markers that the user perceives before other navigational markers in the road scene image. The identified route is modified to positively flag the one or more navigational markers indicated by the user. This information can also be used to update the user-subjective-navigational-marker-perception profile.

For example, if route 760 is identified for the user, the user may be provided with an image of node ii to review. This may be a historic image, e.g. from a map database, or a recent image, e.g. from a CCTV camera located at or near node ii. There may be no known navigational markers located at or near node ii, as shown in FIG. 8. However, a CCTV image of node ii may show a thatched cottage, a house with a cherry blossom tree, and a bench all located near node ii. The user may indicate that they see the cherry blossom tree first. Route 760 can be modified to positively flag the cherry blossom tree, and a route guidance instruction can be provided at node ii accordingly (e.g. turn left after the cherry blossom tree).

In some examples, this may be done for all road segments, nodes or maneuvers that are associated with fewer than a threshold number of perceivable navigational markers. In other examples, this may be limited to a subset, for example only for turning maneuvers, only on particular categories of road, or only when there are several consecutive road segments without a perceivable navigational marker. This may only be done if a confidence level for the identified route is lower than a threshold.

FIG. 12 shows an example computer-readable medium comprising a computer program configured to perform, control or enable the method of FIG. 5 or any other method described herein. The computer program may comprise computer code configured to perform the method(s). In this example, the computer/processor readable medium 1200 is a disc such as a digital versatile disc (DVD) or a compact disc (CD). In other examples, the computer/processor readable medium 1200 may be any medium that has been programmed in such a way as to carry out an inventive function. The computer/processor readable medium 1200 may be a removable memory device such as a memory stick or memory card (SD, mini SD, micro SD or nano SD card). In some example embodiments, the computer/processor readable medium 1200 can be a non-transitory computer readable medium.

It will be appreciated to the skilled reader that any mentioned apparatus/device and/or other features of particular mentioned apparatus/device may be provided by apparatus arranged such that they become configured to carry out the desired operations when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some examples, a particular mentioned apparatus/device may be pre-programmed with the appropriate software to carry out desired operations, and wherein the appropriate software can be enabled for use by a user downloading a “key”, for example, to unlock/enable the software and its associated functionality Such examples can allow a reduced requirement to download data when further functionality is required for a device, and this can be useful in examples where a device is perceived to have sufficient capacity to store such pre-programmed software for functionality that may not be enabled by a user.

It will be appreciated that any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

With reference to any discussion of any mentioned computer and/or processor and memory (e.g. including ROM, CD-ROM etc.), these may comprise a computer processor, Application Specific Integrated Circuit (ASIC), field-programmable gate array (FPGA), and/or other hardware components that have been programmed in such a way to carry out the inventive function.

It will be appreciated that the term “circuitry” may refer to one or more or all of the following: (a) hardware-only circuit implementations (such as implementations in only analogue and/or digital circuitry) and (b) combinations of hardware circuits and software, such as (as applicable): (i) a combination of analogue and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and/or processor(s), such as a microprocessor(s) or a portion of a microprocessor(s), that requires software (e.g. firmware) for operation, but the software may not be present when it is not needed for operation.

This definition of circuitry applies to all uses of this term in this application, including in the claims. As a further example, as used in this application the term circuitry also covers and implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although the foregoing description and the associated drawings describe example embodiments including certain example combinations of features, it should be appreciated that different combinations of features may be provided by alternative embodiments without departing from the scope of the appended claims. In this regard, the applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims.

In view of the foregoing description it will be evident to a person skilled in the art that various modifications may be made within the scope of the disclosure. Therefore, it is to be understood that the disclosure is not to be limited to the specific embodiments described above and that modifications and other embodiments are intended to be included within the scope of the appended claims. It will be understood that various omissions and substitutions and changes in the form and details of the devices and methods described may be made by those skilled in the art without departing from the scope of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or example may be incorporated in any other disclosed or described or suggested form or example as a general matter of design choice. Furthermore, in the claims means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A method comprising:
receiving a request for a route for a user between an origin and a destination;
identifying a route for the user between the origin and the destination using a user-subjective-navigational-marker-perception profile for the user and according to a predetermined suitability criterion, wherein the user-subjective-navigational-marker-perception profile comprises data about the user's subjective perception of navigational markers, and wherein the identified route includes navigational markers along the route which are flagged based on the user-subjective-navigational-marker-perception profile; and
providing the identified route for user navigation.

2. The method of claim 1, wherein the data about the user's subjective perception of navigational markers comprises one or more perceivable navigational marker attributes, wherein a navigational marker having one of these attributes is considered to be perceivable by the user.

3. The method of claim 2, wherein the one or more perceivable navigational marker attributes comprise one or more of:
a colour of navigational marker that the user perceives before other colours of navigational markers;
a type of navigational marker that the user perceives before other types of navigational markers;
a size of navigational marker that the user perceives before other sizes of navigational marker;
a direction relative to a direction of travel along a road segment in which the user perceives navigational markers before other directions relative to a direction of travel;
a distance from the user at which the user perceives navigational markers before other distances from the user;
whether the user perceives permanent or temporary navigational markers first; and
whether the user perceives static or dynamic navigational markers first.

4. The method of claim 2, wherein the data about the user's subjective perception of navigational markers further comprises a perceptibility ranking of perceivable navigational marker attributes, wherein a navigational marker having a higher-ranked attribute is considered to be more perceivable by the user than a navigational marker having a lower-ranked attribute.

5. The method of claim 1, wherein the data about the user's subjective perception of navigational markers comprises one or more unperceivable navigational marker attributes, wherein a navigational marker having one of these attributes is considered to be not perceivable by the user.

6. The method of claim 1, wherein identifying a route for the user between the origin and the destination comprises:
selecting one of a plurality of pre-calculated routes for the user between the origin and the destination.

7. The method of claim 6, wherein one or more of the plurality of pre-calculated routes has an associated attribute describing a category of navigational markers located along the route, and
wherein selecting one of the plurality of pre-calculated routes between the origin and the destination comprises:
comparing the one or more attributes associated with the one or more pre-calculated routes to the user-subjective-navigational-marker-perception profile; and
selecting one of the plurality of pre-calculated routes based, at least in part, on the comparison.

8. The method of claim 6, further comprising:
accessing road network data for a geographic area including the origin and destination, wherein the road network data includes road segment data, node data, a plurality of navigational markers located along the road network, and an association between each navigational marker and one or more road segments or nodes that the respective navigational marker is located on or near, and
wherein selecting one of the plurality of pre-calculated routes between the origin and the destination comprises:
calculating a user perception rating for each of the plurality of pre-calculated routes using the road network data and the user-subjective-navigational-marker-perception profile, wherein the user perception rating represents a perceptibility to the user of the navigational markers along the road segments of the respective route; and
selecting one of the plurality of pre-calculated routes based, at least in part, on the user perception ratings.

9. The method of claim 8, wherein the user perception rating for each pre-calculated route is calculated based on at least one of:
the number of road segments of the route that are associated with more than a threshold number of navigational markers that are perceivable by the user;
the number of road segments of the route that are associated with fewer than a threshold number of navigation markers that are perceivable by the user;
the number of nodes of the route that are associated with more than a threshold number of navigational markers that are perceivable by the user;
the number of nodes of the route that are associated with fewer than a threshold number of navigational markers that are perceivable by the user;
the number of maneuvers in the route that are associated with more than a threshold number of navigational markers that are perceivable by the user;
the number of maneuvers of the route that are associated with fewer than a threshold;
the proportion of the route that is associated with more than a threshold number of navigational markers that are perceivable by the user;
the proportion of the route that is associated with fewer than a threshold number of navigational markers that are perceivable by the user;
a total distance along the route that is associated with more than a threshold number of navigational markers that are perceivable by the user;
a total distance along the route that associated with fewer than a threshold number of navigational markers that are perceivable by the user; or
a maximum single distance along the route that is associated with fewer than a threshold number of navigational markers.

10. The method of claim 8, wherein the road network data further comprises a user perception rating for each of a plurality of road segments and/or nodes, wherein each user perception rating represents a perceptibility to the user of the navigational markers along the respective road segment and/or around the respective node as calculated using the user-subjective-navigational-marker-perception profile for the user, and
wherein the user perception rating for each route is calculated using the user perception ratings for the road segments and/or nodes forming the route.

11. The method of claim 1, further comprising:
accessing road network data for a geographic area including the origin and destination, wherein the road network data includes road segment data, node data, a plurality of navigational markers located along the road network, and an association between each navigational marker and one or more road segments or nodes that the respective navigational marker is located on or near, and
wherein identifying a route for the user between the origin and the destination comprises:
calculating a route between the origin and the destination using the road network data and the user-subjective-navigational-marker-perception profile by maximising a user perception rating for the route, wherein a user perception rating for a route represents a perceptibility to the user of the navigational markers along the road segments of the route.

12. The method of claim 11, wherein the user perception rating for a route is based on at least one of:
the number of road segments of the route that are associated with more than a threshold number of navigational markers that are perceivable by the user;
the number of road segments of the route that are associated with fewer than a threshold number of navigation markers that are perceivable by the user;
the number of nodes of the route that are associated with more than a threshold number of navigational markers that are perceivable by the user;
the number of nodes of the route that are associated with fewer than a threshold number of navigational markers that are perceivable by the user;
the proportion of the route that is associated with more than a threshold number of navigational markers that are perceivable by the user;
the proportion of the route that is associated with fewer than a threshold number of navigational markers that are perceivable by the user;
a total distance along the route that is associated with more than a threshold number of navigational markers that are perceivable by the user;
a total distance along the route that associated with fewer than a threshold number of navigational markers that are perceivable by the user; or
a maximum single distance along the route that is associated with fewer than a threshold number of navigational markers.

13. The method of claim 1, the user-subjective-navigational-marker-perception profile having been generated based on received input from a user for each of a plurality of road scene images, each road scene image including two or more navigational markers, each navigational marker having one or more associated attributes, wherein the received user input indicates one or more navigational markers that the user perceives before other navigational markers in the respective road scene image.

14. The method of claim 1, further comprising generating the user-subjective-navigational-marker-perception profile by:
providing the user with a plurality of road scene images, each road scene image including two or more navigational markers, each navigational marker having one or more associated attributes;
for each of the plurality of road scene images, receiving input from the user indicating one or more navigational markers that the user perceives before other navigational markers; and
storing data about the user's subjective perception of navigational markers based on the received input.

15. The method of claim 13, wherein the input from the user is received via one or more of: a gaze-tracking device, a microphone, a touchscreen, a touchpad, a keyboard and a mouse.

16. The method of claim 1, further comprising:
identifying a road segment, node or maneuver of the identified route which is associated with fewer than a threshold number of navigational markers that are, according to the user-subjective-navigational-marker-perception profile, perceivable by the user;
providing the user with a road scene image for the identified road segment, node or maneuver, the road scene image including two or more navigational markers;
receiving input from the user indicating one or more navigational markers that the user perceives before other navigational markers in the road scene image;
modifying the identified route so that the modified route positively flags the one or more navigational markers indicated by the user and/or negatively flags one or more navigational markers not indicated by the user.

17. The method of claim 1, wherein navigational markers include one or more of: a building, a religious building, a retail building, a gas station, a bus stop, a tram stop, a traffic light, a road sign, a bollard, a bridge, an overpass, a parked vehicle, a non-parked vehicle, a tree, a mailbox, a telephone box, a street lamp, a monument, a bench, a fountain, another item of street furniture, and a pedestrian.

18. The method of claim 1, further comprising:
receiving sensor data from one or more sensors located along road segments of the road network, wherein the sensor data includes the locations of one or more detected navigational markers along one or more road segments of the road network,
wherein identifying the route for the user between the origin and the destination uses the locations of the one or more detected navigational markers.

19. An apparatus comprising:
at least one processor; and
at least one memory including computer program code;
the at least one memory and the computer program code configured to, with the at least one processor, cause the apparatus to:
receive a request for a route for a user between an origin and a destination;
identify a route for the user between the origin and the destination using a user-subjective-navigational-marker-perception profile for the user and according to a predetermined suitability criterion, wherein the user-subjective-navigational-marker-perception profile comprises data about the user's subjective perception of navigational markers, and wherein the identified route includes navigational markers along the route which are flagged based on the user-subjective-navigational-marker-perception profile; and
provide the identified route for user navigation.

20. A computer-readable storage medium comprising instructions which, when executed by a computer, cause the computer to:
receive a request for a route for a user between an origin and a destination;
identify a route for the user between the origin and the destination using a user-subjective-navigational-marker-perception profile for the user and according to a predetermined suitability criterion, wherein the user-subjective-navigational-marker-perception profile comprises data about the user's subjective perception of navigational markers, and wherein the identified route includes navigational markers along the route which are flagged based on the user-subjective-navigational-marker-perception profile; and
provide the identified route for user navigation.
